(19) United States
(12) Patent Application Publication
(10) Pub. No.: US 2019/0319370 A1
(43) Pub. Date: Oct. 17, 2019

(54) WELDING BASE FOR A MICROWAVE DEVICE AND MICROWAVE DEVICE

(71) Applicants: COMBA TELECOM TECHNOLOGY (GUANGZHOU) LTD., Guangzhou (CN); COMBA TELECOM SYSTEMS (CHINA) LTD., Guangzhou (CN); TIANJIN COMBA TELECOM SYSTEMS LTD., Tianjin (CN)

(72) Inventors: Peitao Liu, Guangzhou (CN); Binlong Bu, Guangzhou (CN); Jianjun You, Guangzhou (CN); Hongbin Duan, Guangzhou (CN); Lijing Peng, Guangzhou (CN)

(21) Appl. No.: 16/463,443

(22) PCT Filed: Apr. 26, 2017
(86) PCT No.: PCT/CN2017/081978

§ 371 Date: May 23, 2019

(30) Foreign Application Priority Data
Nov. 23, 2016 (CN) 201611047335.4

(51) Int. Cl. H01R 4/02; B23K 1/20

(52) U.S. Cl. CPC H01R 4/027; B23K 2101/36; H01R 4/023; B23K 1/20

(57) ABSTRACT

The present disclosure relates to the field of welding technology. A welding base for a microwave device includes a cavity and a welding groove defined in the cavity. An inner sidewall of the welding groove is provided with at least one solder-receiving space, and the solder-receiving space extends in an angle with an inner side of the welding groove. In the solution of the disclosure, a solder-receiving space is defined in the inner side of the welding groove, so that part of the solder enters the solder-receiving space when welding, and the solder is stuck in the solder-receiving space after the solder is hardened, and the solder is not easily peeled off.

### FIELD OF THE DISCLOSURE

The present disclosure relates to the field of welding technology for mobile communication devices, and more particularly to a welding base for a microwave device and a microwave device using the welding base.

### BACKGROUND OF THE DISCLOSURE

At present, microwave devices are often used in the field of microwave communication technology. Especially in the field of communication, the stability of electrical performance of microwave devices is very important. Microwave devices require connecting external cables, and among the existing material options for microwave device, aluminum alloys are commonly used, but aluminum alloy itself cannot be welded directly to the cable by welding. Therefore, it is often necessary to perform overall electroplating to the microwave device before welding. However, due to the high cost of electroplating the entire device itself and due to the part needed to be welded is only a small part, the cost is too high.

In order to solve the above problem, in the method, application method and connection structure of welding between a weldable conductor and non-weldable base of patent number CN201510515683.9, a scheme for spraying a weldable material on a microwave device is proposed to achieve welding between a weldable conductor and a non-weldable base.

However, in this prior art, there are the following problems: the phenomenon of solder falling off from the welding substrate is common, especially in surface welding or in welding at solder joints having welding grooves, the to-be-welded member is easy to fall off from the welding base carrying solder. For welding between the aluminum welding base and coaxial cable (the to-be-welded), coating is generally needed, usually by spraying a layer of copper in the welding groove of the aluminum-welding base, that is, copper coating. Although copper coating is done, connection between the aluminum base and coaxial cable is relatively strong after welding, and its vibration resistance and tensile strength are still weak. When the welding joint is subjected to large vibration or when the coaxial cable is pulled hard, the coaxial cable is easy to fall off from the welding groove of the welding base carrying solder.

It can be seen that the traditional welding is not strong, the reliability is poor, and there are potential safety hazards, and the stability of electrical performance of microwave devices cannot be ensured.

### SUMMARY OF THE DISCLOSURE

Embodiments of the disclosure are directed to the problem of the welding point not being strong and the solder is easy to fall off in the welding method of a prior art microwave device, and provide a microwave device and a welding base thereof with simple structure and improved reliability of connection between a welding base and a to-be-welded member.

A welding base for a microwave device includes a cavity and a welding groove defined in the cavity. An inner sidewall of the welding groove is provided with at least one solder-receiving space, and the solder-receiving space extends in an angle with an inner side of the welding groove, such that structure is formed that causes physical interference between solder and the welding groove after cooling and curing, thus blocking the movement of the solder relative to the welding groove, and preventing the solder and the to-be-welded member from falling off the welding groove.

In one embodiment, the at least one solder-receiving space is uniformly or dispersedly defined in the inner sidewall of the welding groove.

In one embodiment, a plurality of said solder-receiving spaces is distributed on a same cross section of the welding groove.

In one embodiment, when the at least one solder-receiving space is uniformly disposed inside the welding groove, the solder-receiving spaces are defined in pairs in the welding groove at a location of the same height.

In one embodiment, the distance between every two adjacent solder-receiving spaces on a same cross section is equal.

In one embodiment, the solder-receiving space is disposed at an intersection of a side and a bottom of the welding groove.

In one embodiment, the solder-receiving space includes a slot disposed in the inner sidewall of the welding groove.

In one embodiment, the inner sidewall of the welding groove is uneven to form the slot.

In one embodiment, the solder-receiving space includes a through hole passing through the inner sidewall of the welding groove and/or a blind hole defined in the inner sidewall of the welding groove.

In one embodiment, the welding base for the microwave device is formed by an extrusion or die casting process.

A microwave device uses a welding base as described above.

Compared with the prior art, the present disclosure has the following advantages.

According to the solution of the present disclosure, a solder-receiving space is defined in the inner side of the welding groove, and the solder-receiving space extends in a direction that is at an angle relative to the inner sidewall of the welding groove. Therefore, during welding, part of the solder enters the solder-receiving space, and after the solder is cooled and cured, the solder is trapped in the solder-receiving space. The solder is not easily detached from the welding groove, which solves the problem that the welding joint is not strong and the solder is easy to fall off in the existing microwave device welding scheme. The welding base for the microwave device of the disclosure has the characteristics of firm and reliable welding joints, thereby ensuring the reliability of the electrical connection of the microwave device. In addition, the welding base of for the microwave device has simple structure and is formed by an extrusion or die-casting process, and has good consistency and is convenient for mass production.

### BRIEF DESCRIPTION OF THE DRAWINGS

In order to more clearly illustrate the embodiments of the present disclosure, the drawings used in the embodiments will be briefly described below. The drawings in the following description are only some embodiments of the present disclosure, but the disclosure is not limited thereto.

FIG. 1 is a schematic structural view of a welding base for a microwave device according to an embodiment of the present disclosure;

FIG. 2 is a schematic structural view of a welding base for a microwave device according to another embodiment of the present disclosure;

FIG. 3 is a schematic structural view of a welding base for a microwave device according to a further embodiment of the present disclosure; and

FIG. 4 is a schematic structural view of a microwave device according to an embodiment of the present disclosure.

### DETAILED DESCRIPTION OF THE DISCLOSURE

The disclosure is further described in the following with reference to the drawings and exemplary embodiments, which are illustrated in the accompanying drawings, in which the same or similar reference numerals are used to refer to the same or similar elements or elements having the same or similar functions. The embodiments described below with reference to the drawings are intended to be illustrative of the disclosure and are not to be construed as limiting. Further, if a detailed description of a known technique is not necessary to show the features of the present disclosure, it will be omitted.

Specific embodiments of the disclosure are described in detail below.

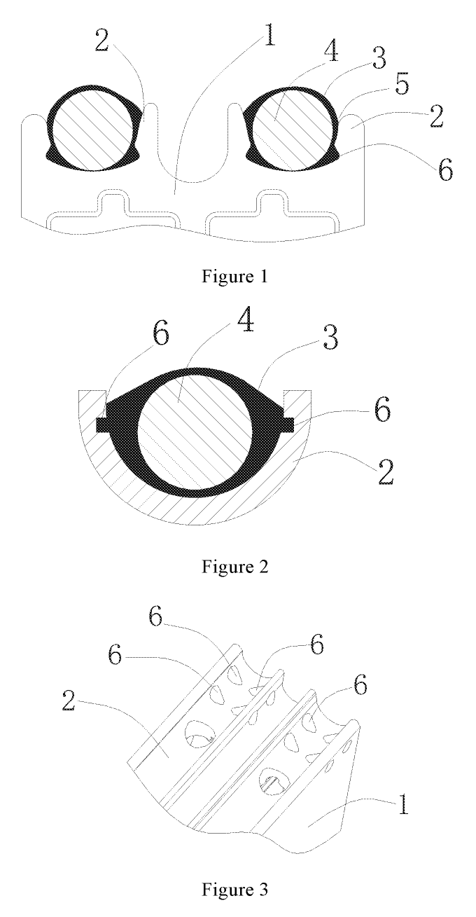

In one embodiment of the present disclosure, and particularly referring to FIG. 1 which is a partial schematic view of an embodiment of a welding base for a microwave device of the present disclosure, showing the structure of a welding base for a microwave device at a welding joint.

A welding base for a microwave device (hereinafter referred to as “welding base”) includes a cavity 1 and a welding groove 2 and at least one solder-receiving space 6. The welding groove 2 is defined in the cavity 1 for accommodating a to-be-welded member 4, and the to-be-welded member 4 is welded to an inner sidewall 5 of the welding groove 2 using solder 3. The solder-receiving space 6 is defined in the inner sidewall 5 of the welding groove 2 for forming physical interference structure with the inner sidewall of the welding groove after the solder is cooled and cured. The solder 3 is blocked in order to restrict the longitudinal movement of the solder, thereby preventing the solder 3 from falling out of the welding groove 2, and ensuring the reliability of the connection between the to-be-welded member and welding base.

When the to-be-welded member 4 is welded to the inner sidewall 5 of the welding groove 2 using the solder 3, because the solder-receiving space 6 is defined in the inner sidewall 5, when the solder 3 is in a molten state and covers the to-be-welded member 4 and the solder-receiving space 6, the solder 2 flows into the solder-receiving space 6, so that the solder 3 is partially fixed in the solder-receiving space 6 during curing. Thereby, the solder 3 is held in place, the longitudinal movement of the solder is blocked, and therefore, even if the solder is loosened at the welding joint, it would not fall off from the welding groove 2, hence improving the reliability of the connection between the welding base and the to-be-welded member.

In one embodiment, in application, in order to improve the welding effect, the welding groove may be plated and sprayed with a weldable material to enable better connection between the inner sidewall of the welding groove and the solder.

Referring to FIGS. 2-3, furthermore, in an embodiment of the present disclosure, the at least one solder-receiving space 6 is uniformly or dispersedly disposed on the inner sidewall 5 of the welding groove 2.

Specifically, when the at least one solder-receiving space 6 is uniformly disposed on the inner sidewall of the welding groove 2, a plurality of the solder-receiving spaces 6 is distributed on a same cross-section of the welding groove 2. The solder-receiving spaces 6 are defined in pairs in the welding groove 2 at a location of the same height. In one embodiment, the distance between every two adjacent solder-receiving spaces on a same cross section is equal.

In one embodiment, the solder-receiving space 6 is disposed at an intersection of a side and a bottom of the welding groove 2.

In an embodiment of the present solution, the solder-receiving space 6 is at least one of a slot defined in the inner sidewall 5 of the welding groove 2, a through hole and a blind hole defined in the sidewall of the welding groove 2.

In one embodiment, the inner sidewall 5 of the welding groove 2 is uneven to form the slot.

The welding base for a microwave device of the disclosure has simple structure, and the cavity 1 and the welding groove 2 can be formed by a process such as extrusion, die casting, etc., which is advantageous for mass production.

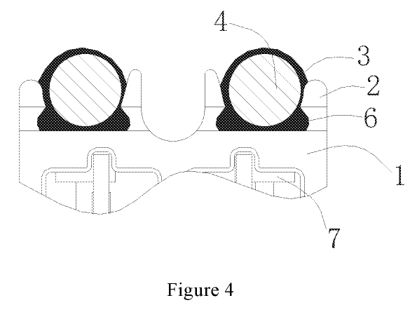

Furthermore, as shown in FIG. 4, the present disclosure also relates to a microwave device using a welding base as described above, and a microwave network 7 of the microwave device is disposed in the cavity 1. Due to use of the welding base for a microwave device, in the microwave device of the present disclosure, the connection between the welding base and the to-be-welded member is firm and reliable, thereby making the signal transmission of the microwave device safe, stable and reliable.

While the disclosure has been described in detail, the embodiments of the disclosure may be practiced without these details. In some embodiments, well-known methods, structures, and techniques have not been shown in detail so as not to obscure the understanding of the present specification.

What is claimed is:

1. A welding base for a microwave device, comprising:
a cavity; and
a welding groove defined in the cavity,
wherein an inner side wall of the welding groove is provided with at least one solder-receiving space, and the at least one solder-receiving space extends at an angle relative to an inner sidewall of the welding groove.

2. The welding base for a microwave device as recited in claim 1, wherein the at least one solder-receiving space is uniformly or dispersedly defined in the inner sidewall of the welding groove.

3. The welding base for a microwave device as recited in claim 2, wherein a plurality of said solder-receiving spaces are distributed on a same cross section of the welding groove.

4. The welding base for a microwave device as recited in claim 2, wherein when the at least one solder-receiving space is uniformly defined in the inner sidewall of the welding groove, the plurality of solder-receiving spaces are defined in a pair of inner sidewalls of the welding groove.

5. The welding base for a microwave device as recited in claim 4, wherein the distance between every two adjacent solder-receiving spaces on a same cross section is equal.

6. The welding base for a microwave device as recited in claim 1, wherein the solder-receiving space is disposed at an intersection of a side and a bottom of the welding groove.

7. The welding base for a microwave device as recited in claim 1, wherein the solder-receiving space includes a slot disposed in the inner sidewall of the welding groove.

8. The welding base for a microwave device as recited in claim 7, wherein the inner sidewall of the welding groove is uneven to form the slot.

9. The welding base for a microwave device as recited in claim 1, wherein the solder-receiving space includes a through hole passing through the inner sidewall of the welding groove and/or a blind hole defined in the inner sidewall of the welding groove.

10. The welding base for a microwave device as recited in claim 1, wherein the welding base for the microwave device is formed by an extrusion or die-casting process.

11. A microwave device comprising:
welding base for a microwave device, comprising:
a cavity; and
a welding groove defined in the cavity,
wherein an inner side wall of the welding groove is provided with at least one solder-receiving space, and the at least one solder-receiving space extends at an angle relative to an inner sidewall of the welding groove.
